(19) United States
(12) Patent Application Publication
(10) Pub. No.: US 2004/0195431 A1
(43) Pub. Date: Oct. 7, 2004

(54) Hard shell lighter than air orbiter

(76) Inventors: Paul Selcuk Yumlu, Clearwater, FL (US); Salih V. Yumlu, Haggerstown, MD (US); Phillip H. R. Epps, Margate, FL (US)

Correspondence Address: Paul S. Yumlu, 235 Windward Passage, Clearwater, FL, 33767, US

(21) Appl. No.: 10/373,300

(22) Filed: Feb. 26, 2003

(51) Int. Cl. B64D 5/00

(52) U.S. Cl. 244/2

(57) ABSTRACT

The main idea is using hydrogen inside a bard shell, to create a lighter than air ship. It would be very aero dynamic, and using the newest carbon-carbon fiber and resins that would make up the internal beams, rods and skin. The top of the ship will be covered with solar cells. The bottom with liquid nitrogen tubes running through out to cool during re-entry.

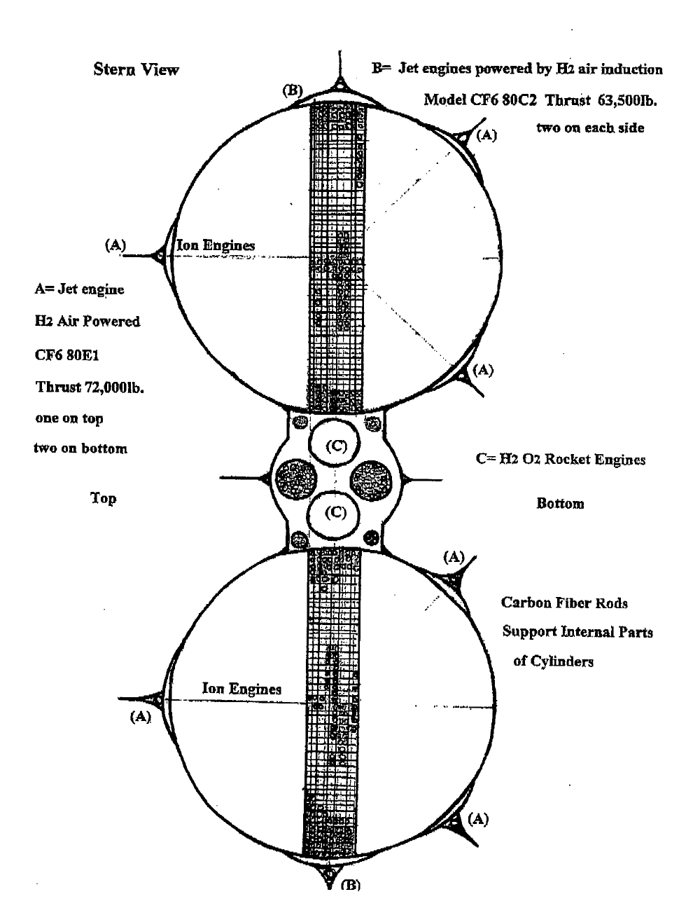

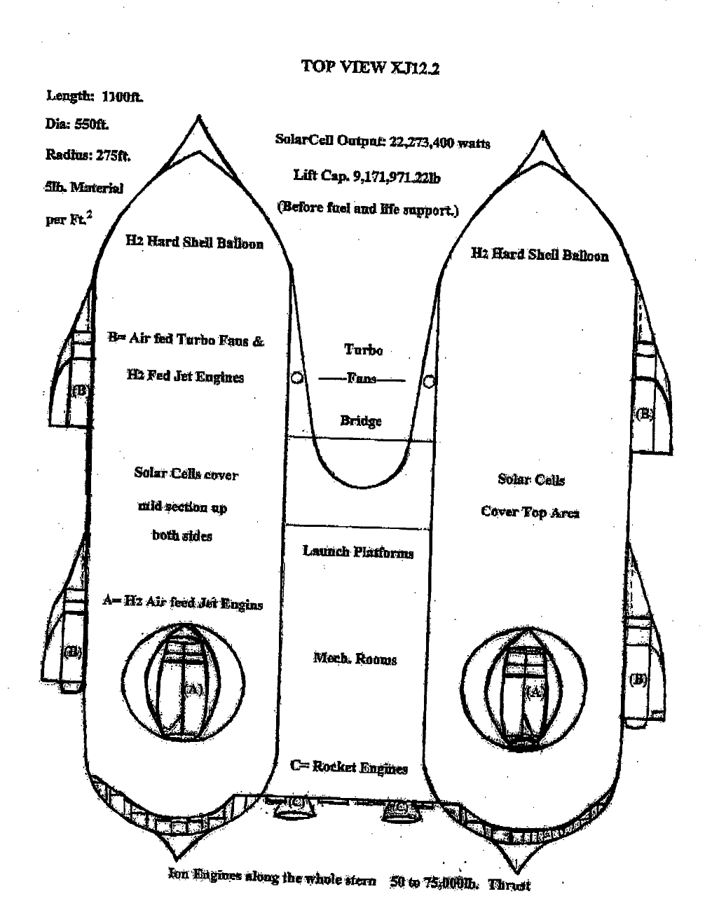

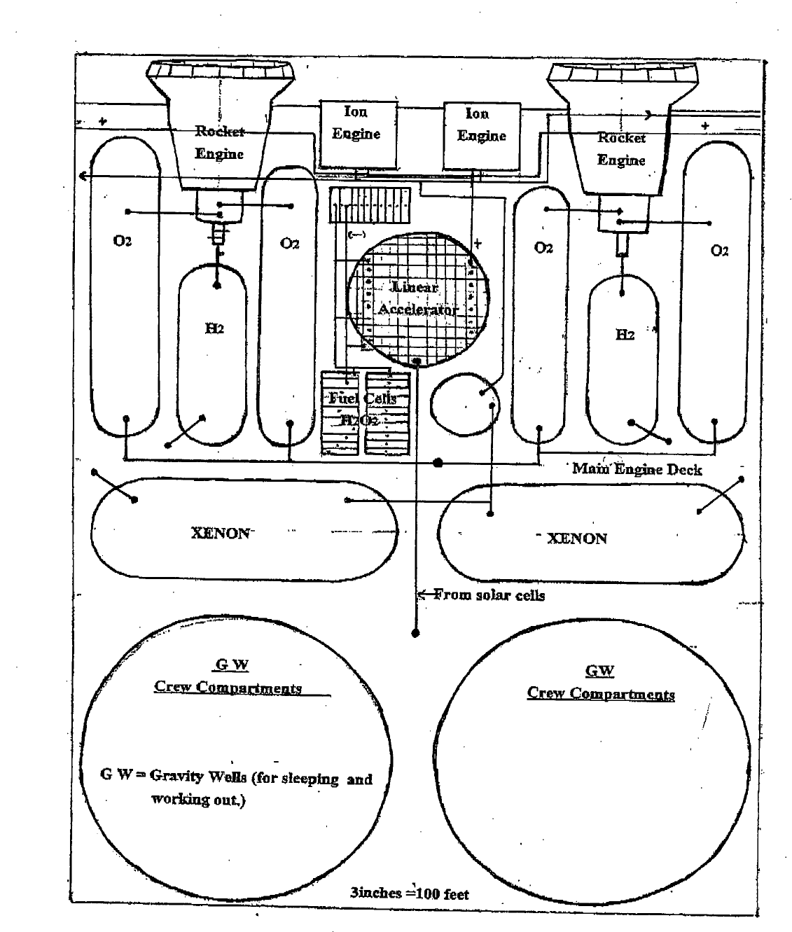

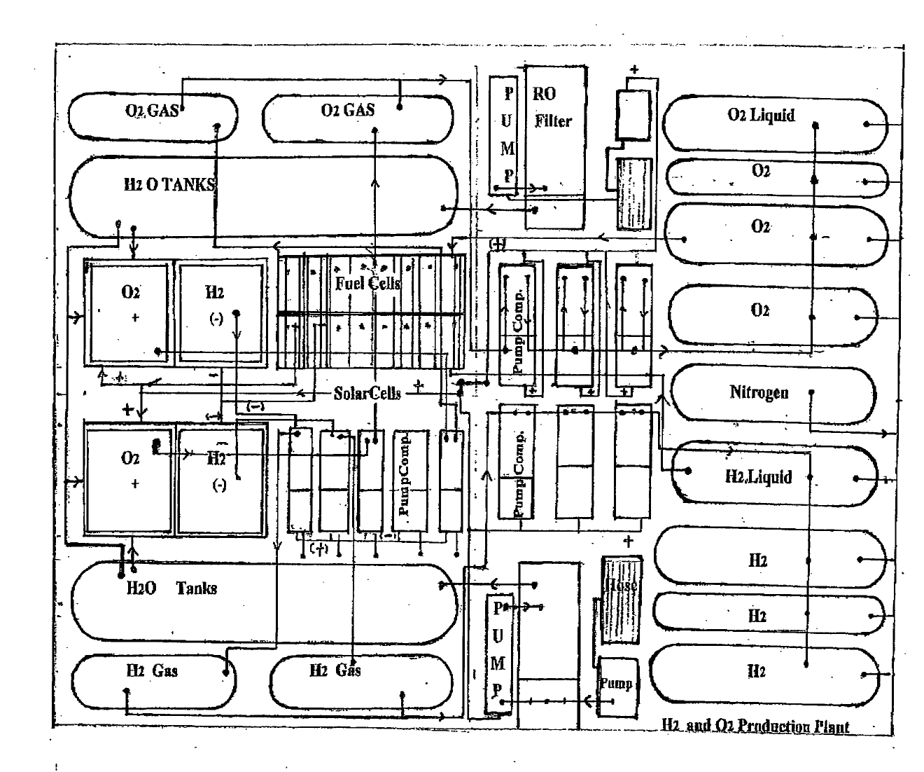

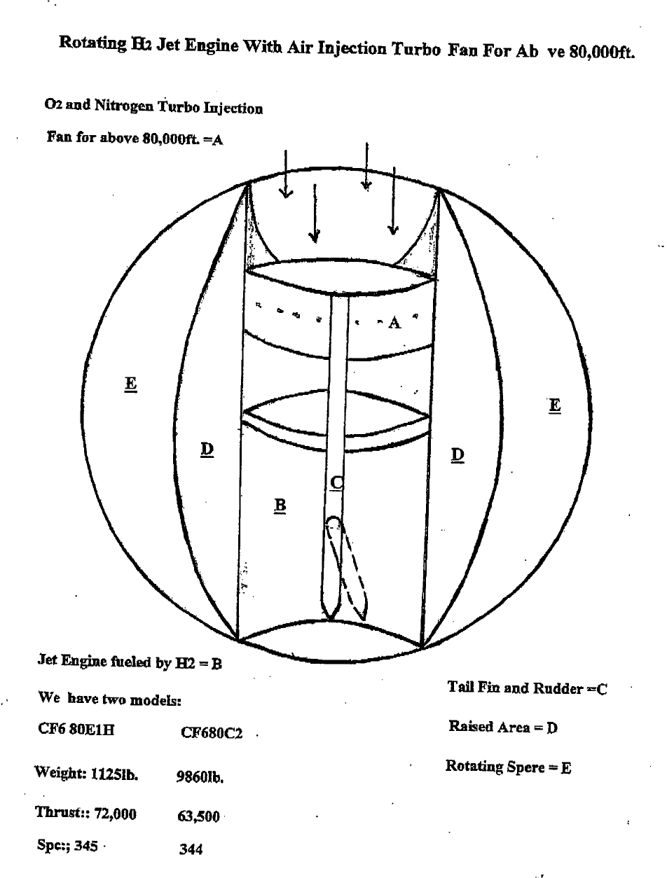

Unlike normal rockets this ship will orbit the earth building up velocity and altitude, with Ion engines and air injected jet engines. By being lighter than air we will be able to build up velocity with less fuel or thrust. When escape velocity is reached the liquid fuel rockets would make the final assent into space on a horizontal or parallel line with the earth. The reason Ion engines will work is the linear accelerators that would increase the thrust to useable levels.

The gravity wells would make it possible to stay in space a lot longer.

What I claim as my invention is a hard shell lighter than air space orbiter, composed of lightweight composite Carbon-Carbon fibers, laminated with epoxy resins, with two aerodynamic cylinders, connected in the middle, by a aerodynamic rectangular deck, where the crew would reside, with mechanical rooms and engines in the aft section.

I further claim power would come from solar cells, (which would cover most of the surface area above the midway point) and H2 and O2 fuel cells. These would power the turbo fans for lower altitudes, and the Linear Accelerator(s), which would power the Ion Engines. There would also be H2 and air fueled jet engines for various uses. The final thrust into orbit would be done with pure H2 and oxygen rocket engines and the H2 air supplied jet engines.

Mechanical rooms would consist of compressed tanks for oxygen, H2 and the H2 fuel cells, xenon gas and nitrogen. Along with the high-pressure pumps, compressors, generators and all cabin life support systems.

Production H2+O2 would be produced on board the Ship, over fresh water, lakes, or rivers, if necessary seawater could be used. the water would be well filtered.

Turbo fans would be useful in maneuvering close to the ground and for low orbit transportation. But the air induction H2 jet engines and two rear rocket engines would be the main workhorse leaving the atmosphere. Ion Engines would build up speed while orbiting until we reached escape velocity, and then after 70,000 ft. the H2 O2 engines would make the final push out into orbit. This ship would not use a direct vertical takeoff. Instead it would orbit the earth ever increasing altitudes and speed, until it reaches space with a horizontal or parallel line with the earth out into space.

### Use

Industrial, commercial and military

Reach orbit using much less fuel.

Contracts to launch satellites.

Salvage service to recycle and clean up orbital debris.

Win the X-prize, first private entity in space.

When filled with helium, could be use for transportation here on earth.

Launch Platform for Jets and Helicopters.

Rocket Launch Platform for satellites or probes.

Tourism and transportation.

Meteorite Deflection.

Telescope Delivery.

Mining meteorites.

Build an elevator to space.

Military Laser Platform.

### Engineering Submittals

Carbon-Carbon fiber rods would support the hard shell cylinders; this would protect from expansion in a vacuum, and or above 90,000 feet,

It may be necessary to have ballonets; soft balloons inside the hard shell compartmented, and controlled by pumps from pressurized gas cylinders.

The Ion Engine Boeing 702 thruster has 0.036 lb. thrust. With ISP of 3800 seconds, but it also uses 4500 watts of power. It is also 25 cm in diameter. A Linear accelerator could accelerate the charged gasses to speeds sufficient to give the specific impulse of a million or more. On a 702 this would give you 9.47 lbs. thrust. With my solar cell and H₂ O₂ fuel cells I should be able to maintain 50 to 75,000 lbs. of thrust.

This ship will produce it's own H₂ O₂ as in detail 0.001 even at 10 amps DC over 24 hrs. we can produce 100. liters. H₂, of course we will be using a much higher ampridges so we will be able to produce large quantities of gas in a small amount of time.

The thrust levels of the air fed H₂ jet engines are an estimate. (See page 0.004)

The XJ12.2 is my pick it is one of the biggest I have done the math on.

The volume=261,341,238.9 sq. ft. that's each cylinders.

| V × the lift cap. of H2 which is .0691 | | |
|---|---|---|
| V × .0691 = 18,058,679.61 lift cap. | 18,058,679.61 | lift cap. |
| Now the surface area of each cylinder | | |
| is roughly: | | |
| SA = 2,375,829.44 × 5 lbs. Per Sq. | − 11,899,147.20 | lbs. |
| Ft. = 11,899,147.20 lbs. weight of cylinder. | | |
| Solar cell output = 77,000,000 to | | |
| 140,000,000 watts. | | |
| V × Density of H2 = 1,437,376.8 lb. = | − 1,437,376.8 | lbs. |
| weight of H2 in each cylinder. | | |
| | 4,722,155.61 | lbs. |

| | | |
|---|---|---|
| Lift Cap. | 4,722,155.61 | |
| | + 4,722,155.61 | |
| | 9,444,311.22 | lift cap. of both cylinders |
| | 9,444,311.22 | lift cap. of both cylinders |
| | − 412.340.00 | Crew Comp. and engines |
| | 9,031,971.22 | |
| | 9,031,971.22 | |
| | − 399,139.30 | weight of Emcore solar photovoltaic cells |
| | 8,632,831.92 | lift cap. of both cylinders |

This does not include the weight of the fuel, but I would estimate the weight at 3,000,000 lbs. There is also a lot of technical data which weight has not been included.

1. What I claim as my invention is a hard shell lighter than air space orbiter, composed of lightweight composite Carbon-Carbon fibers, laminated with epoxy resins, with two aerodynamic cylinders, connected in the middle, by a aerodynamic rectangular deck, where the crew would reside, with mechanical rooms and engines in the aft section.

2. It would orbit the earth at an ever-increasing altitude and speed until at a given altitude it would reach escape velocity and reach space on a horizontal or parallel line with the earth.

3. The carbon fiber technology is increasing, and can in the very near future bring the weight to lift ratio to even much more favorable status, making orbit with much less fuel, and therefore much smaller lighter than air craft, even small enough for cars and trucks here on earth.
